(19) United States
(12) Patent Application Publication
(10) Pub. No.: US 2015/0112811 A1
(43) Pub. Date: Apr. 23, 2015

(54) Method for Tailoring a Web Advertisement to a Specific User Adapting for Display on a Mobile Device

(71) Applicant: Trion Interactive LLC, Hammonton, NJ (US)

(72) Inventors: Chris Connors, Brooklawn, NJ (US); Thomas J. Kohler, JR., Mt. Laurel, NJ (US); Albert J. Shermer, III, Voorhees, NJ (US); James Vincenzo Penza, Hammonton, NJ (US)

(21) Appl. No.: 14/487,682

(22) Filed: Sep. 16, 2014

Related U.S. Application Data
(60) Provisional application No. 61/878,124, filed on Sep. 16, 2013.

(51) Int. Cl. G06Q 30/02

(52) U.S. Cl. CPC G06Q 30/0267
USPC 705/14.64

(57) ABSTRACT

A method for tailoring an advertisement to a specific user based upon that user's available information, then adapting a suitable advertisement for display on a mobile device, and then delivering that advertisement on the user's mobile device.

### CROSS-REFERENCE TO RELATED APPLICATIONS

This application claims the benefit of U.S. Provisional Patent Application Ser. No. 61/878,124, entitled Method for Tailoring a Web Advertisement to a Specific User Adapting for Display on a Mobile Device, filed Sep. 16, 2013, the full disclosure of which is incorporated herein by reference in its entirety.

### BACKGROUND

The latest generation smart phones coupled with today's 4G wireless network has granted consumers unprecedented remote access to the Internet. With Internet commerce centered around advertisements placed on websites, advertisers have an interest in making sure that their advertisements reach the intended audience and are displayed correctly.

Most advertisements are designed to display properly on a computer monitor. Mobile devices have display screens far smaller than computer monitors, creating situations where advertisements may not display properly. Technology dedicated to preferring certain advertisements based on user information and then adapting those preferred ads effectively to a mobile device is desirable.

### BRIEF DESCRIPTION OF THE DRAWINGS

These and other features, aspects, and advantages of the disclosure will become better understood with regard to the following embodiment of the present invention, appended claims, and accompanying drawings where:

FIG. 1 is a flow chart illustrating the method of preferring an advertisement for a particular user.

FIG. 2 is a flow chart illustrating the method of re-sizing a video for display on a mobile device.

FIG. 3 is a flow chart illustrating the method of re-sizing an image for display on a mobile device.

FIG. 4 is a diagram of the system components.

FIG. 5 is a diagram displaying general purpose computer on which the system and method of the present disclosure may be implemented according to an aspect of the present disclosure.

### DETAILED DESCRIPTION

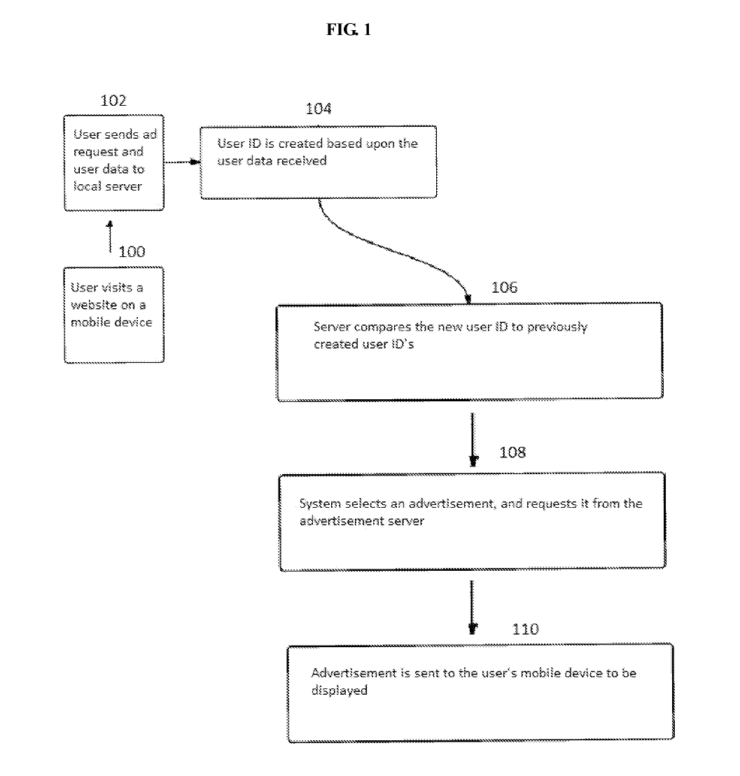

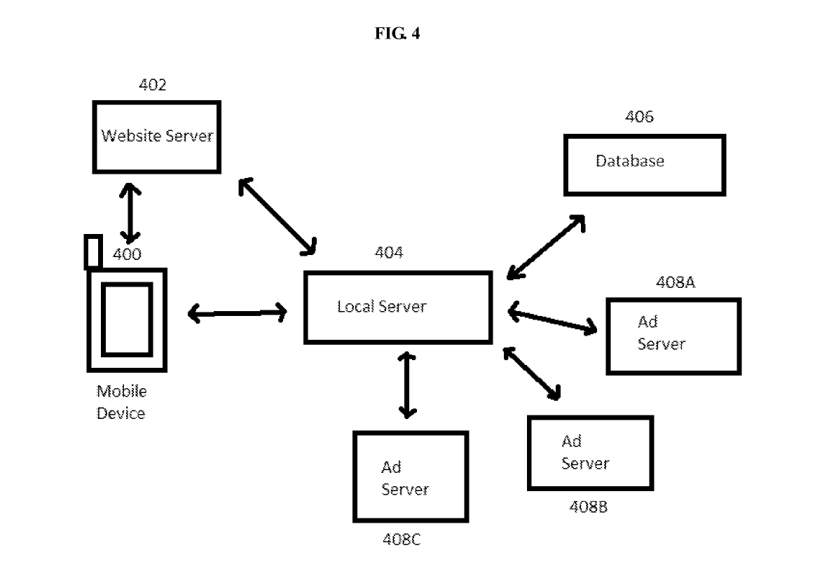

Referring now to FIGS. 1, 2, 3, and 4, this aspect of the present invention includes software capable of running on any device utilizing HTML5 standards, or an application using HTML5 web-views. As shown in FIG. 4, this illustration of the aspect of the invention utilizes steps that may take place on or using a local server 404, a user's mobile device 400, a website server 402, and on one or more third party advertisement servers 408A, 408B, 408C. There may also be a database 406 where information is stored. The following steps are merely illustrative of this particular aspect of the invention, and are not required.

Before an advertisement is modified and delivered to mobile device 400, the software may try to determine which content and form would most likely be well-received by the user. If an appropriate advertisement is selected, it may be transformed from its original form to a mobile form, allowing it display properly on mobile device 400.

FIG. 1 displays the flowchart illustrating how this aspect of the invention selects an advertisement based on information provided by the user. First, at step 100, the user requests a webpage on a mobile device 400 such as a smart phone or tablet. When the user visits a webpage, instructions in the webpage's code causes the user's mobile device to send an advertisement request the local server 404 at step 102. Along with the advertisement request, the user's mobile device 400 may send available user data to the local server 404, such as: browser header information, time of day, webpage where the request originated, location data, device type, operating system, additional parameters, IP address, and IP address type, as shown in step 102, and this data may be stored as user identifiers in a database 406.

This aspect of the invention uses the user identifiers to create a unique user ID for each user generated advertisement request at step 104. The user ID may be generated on the local server 404 based upon the identifiers received, and in step 106 the local server 404 may compare the newly generated user ID to a database 406 of existing user ID's created previously. When a matching user ID is found, the system backend on the local server 404 may select and request certain advertisements over others at step 108. The backend 404 may evaluate the information and determine whether a direct advertisement deal is available from one or more advertisement servers 408A, 408B, 408C. If multiple direct advertisement deals exist, the system backend on the local server 404 may determine which advertisements are best suited for the particular user, as shown in step 108, which may be based upon the identifiers stored in the database 406. In step 110, the local server 404 may send the selected advertisement to the user's mobile device 400.

For example, suppose a user visits www.newjerseyshoresports.com at step 100. Assuming that webpage worked in conjunction with the present system, the user's mobile device 400 would send a request for webpage information and then receive website info including instructions to send an advertisement request and any other available user identifiers to the local server 404 at step 102. The local server would then store the user identifiers on a database 406. Then the backend on the local server 404 would assign the data a user ID at step 104 and then determine whether any matching user ID's were found in the database 406 at step 106. Then, at step 108 the backend will likely conclude that, based upon the provided identifiers and the corresponding user ID, the user was likely a male aged 18-24 located near the beach. Then, the backend would select male-oriented advertisements for that age and geographic region such as sporting equipment for the beach or swimwear, request such an advertisement from an advertisement server 408A. At step 110, the local server 404 would send that advertisement to the website server 402 to be displayed on the user's mobile device 400. Comparing user IDs allows the system to make an educated guess of unique and repeat visitors, and allows the system to make an educated determination on which advertisement is more likely to suit a particular visitor.

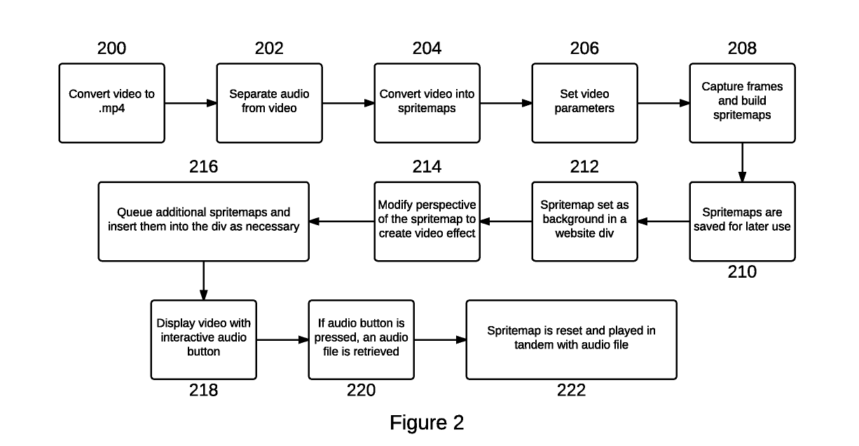

Once an advertisement is selected for delivery to the user, it may be adapted to display properly on a mobile device 400. The selected advertisement may be a video originally designed for display on a large computer screen. FIG. 2 illustrates by example how this aspect of the present invention adapts an advertisement for mobile use. Parts and steps are modifiable and interchangeable without deviating from the spirit of the invention. First, an advertisement video may be sent to the local 404 server in response to an advertisement request. This video may be converted into an .mp4 file by the local server using an H.264 codec or other similar codec as shown in step 200. The aspect ratio of the video may be preserved by “letterboxing”. The entire file may be kept to below 2 MB by splitting the audio from the video in step 202, and modifying the bitrate. Presently, files above 2 MB experience various difficulties when being displayed on mobile web browsers.

The video may be converted to a spritemap either manually or automatically using a converter program on the local server 404, which is shown in step 204. The height, frames per second, quality and the video parameters may be set in the converter program to adjust file size, shown in step 206. The conversion is then started, and appropriate video frames may then be captured using an HTML5 canvas to build the spritemap(s) at step 208. The resulting spritemap may be a long narrow image one frame in height, and hundreds of frames wide and may then be saved to the local server 404 at step 210. To create an illusion of video on the user's mobile device 400, the local server 404 may send the spritemap(s) to the website server 402 along with display instructions. The website then displays the spritemap in accordance with the instructions on a div as shown in step 212. A div is a space overlaying the main web page where interactive elements may be placed in a closed environment. The display instructions may include a timer that causes the user's perspective of the spritemap to change in a side scrolling manner at the appropriate FPS to create the illusion of video on the mobile device 400 as shown in step 214.

If a single spritemap is not large enough to contain the entire video, a second spritemap may be queued up and continue after the first spritemap finishes in step 216. An audio button may be added inset in the div displayed on the user's mobile device 400 at step 218. If the user presses the button, the user's mobile device 400 may reset the div to the first frame of the first spritemap, and then an audio file is retrieved from the local server 404 at step 220. The user's mobile device 400 may then display the spritemap in tandem with the audio file to create an audio visual experience at step 222.

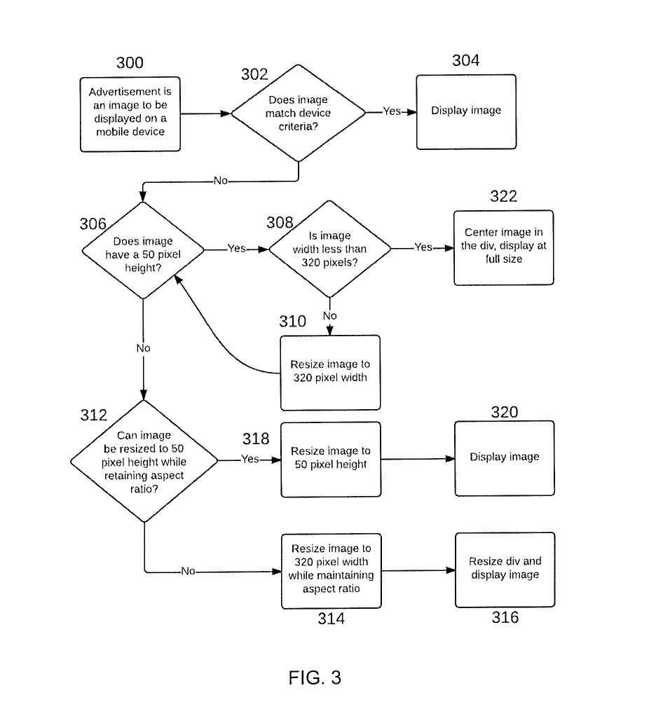

If the selected advertisement is an image designed for display on a large computer screen, FIG. 3 illustrates by example how this aspect of the present invention adapts it for mobile use. First, the advertisement server may submit to the local server 404 an image designed for a large screen to be displayed on a smaller mobile device 400 screen at step 300. An image-dimensions check may be done on the user's mobile device at step 302, whereby if the image in its original state can be displayed on the smaller mobile device 400 screen without being resized in order to be viewed in its entirety, it may be displayed on the mobile device 400 at step 304. If the image would need to be resized, a second check may be done by the mobile device 400 to determine whether the image has a height of 50 pixels at step 306. A height of 50 pixels is not essential to the operation of the system, but it has been set by the advertising bureau as a preferred dimension for image advertisements on mobile devices. If the image does not have a 50 pixel height, the mobile device 400 may determine if the image can be resized to 50 pixel height while maintaining the image's aspect ratio in step 312. If it can't, the picture may be resized by the user's mobile device to a 320 pixel width while maintaining the image's aspect ratio in step 314. 320 pixels is not essential to the operation of the system, but has been selected by the present aspect of the invention because at this value, the image will stretch from one side of the mobile device screen to the other, without leaving empty space on most mobile devices. Some mobile devices operate with a 360 pixel screen width. On these devices, an image having a 320 pixel width may be scaled up by the local server 404 to fit the 360 pixel screen. For example, a 320×50 ad displaying on a 360 pixel width mobile device may be scaled by the local server 404 to 360×56.25 pixels and then displayed on the 360 pixel width mobile device 400. Then the image height may be used to adjust the div on the website accordingly and the image may be displayed on the user's mobile device 400 at step 316. If the image can be re-sized to a 50 pixel height, it is re-sized accordingly and displayed at steps 318, and 320.

If the image has a 50 pixel height, a third check may be done by the mobile device 400 to determine if the width is less than 320 pixels at step 308. If the image has a 50 pixel height, and has a width greater than 320 pixels, its width may be re-sized to 320 pixels and the image rechecked for a 50 pixel height at steps 310, and 306. If the image has a height of 50 pixels, and a width less than 320 pixels, the image may be centered on the website div and displayed at full size at step 322.

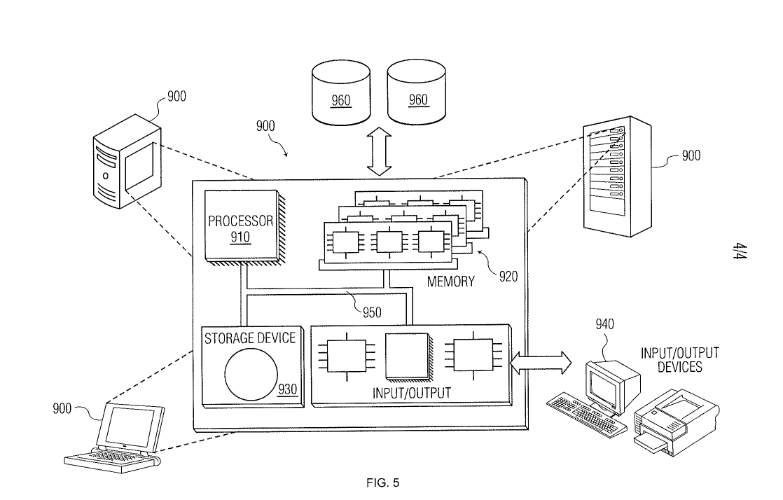

FIG. 5 shows a general purpose computer on which the system and method of the present disclosure may be implemented. The computer system 900 may execute at least some of the operations described above. Computer system 900 may include processor 910, memory 920, storage device 930, and input/output devices 940. Some or all of the components 910, 920, 930, and 940 may be interconnected via system bus 950. Processor 910 may be single or multi-threaded and may have one or more cores. Processor 910 may execute instructions, such as those stored in memory 920 or in storage device 930. Information may be received and output using one or more input/output devices 940.

Memory 920 may store information and may be a computer-readable medium, such as volatile or nonvolatile memory. Storage device 930 may provide storage for system 900 and may be a computer-readable medium. In various aspects, storage device 930 may be a flash memory device, a floppy disk device, a hard disk device, an optical disk device, or a tape device.

Input/output devices 940 may provide input/output operations for system 900. Input/output devices 940 may include a keyboard, pointing device, and microphone. Input/output devices 940 may further include a display unit for displaying graphical user interfaces, speaker, and printer. External data, such as financial data, may be stored in accessible external databases 960.

The features described may be implemented in digital electronic circuitry, or in computer hardware, firmware, software, or in combinations thereof. The apparatus may be implemented in a computer program product tangibly embodied in an information carrier, e.g., in a machine-readable storage device or in a propagated signal, for execution by a programmable processor; and method steps may be performed by a programmable processor executing a program of instructions to perform functions of the described implementations by operating on input data and generating output.

The described features may be implemented in one or more computer programs that are executable on a programmable system including at least one programmable processor coupled to receive data and instructions from, and to transmit data and instructions to, a data storage system, at least one input device, and at least one output device. A computer program may include set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors of any kind of computer. Generally, a processor may receive instructions and data from a read only memory or a random access memory or both. Such a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable, disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks may include, e.g., a LAN, a WAN, and the computers and networks forming the Internet.

The computer system may include clients and servers. A client and server may be remote from each other and interact through a network, such as the described one. The relationship of client and server may arise by virtue of computer programs running on the respective computers and having a client-server relationship to each other.

Numerous additional modifications and variations of the present disclosure are possible in view of the above teachings. It is therefore to be understood that within the scope of the appended claims, the present disclosure may be practiced other than as specifically described herein.

1. A process for selecting an advertisement and sending the advertisement to a mobile device comprising:
receiving an advertisement request and user data from the mobile device;
using the user data to select an advertisement from a plurality of available advertisements; and
sending the selected advertisement to the mobile device.
